(19) United States
(12) Patent Application Publication
(10) Pub. No.: US 2013/0032744 A1
(43) Pub. Date: Feb. 7, 2013

(54) VALVE HAVING AN ELASTOMER/CERAMIC SEALING RING

(71) Applicant: Dominique Duboy, Gradignan (FR)

(72) Inventor: Dominique Duboy, Gradignan (FR)

(21) Appl. No.: 13/582,172

(22) PCT Filed: Nov. 25, 2010
(86) PCT No.: PCT/FR2010/000784

§ 371 Date: Sep. 19, 2012

(30) Foreign Application Priority Data
Mar. 1, 2010 (FR) 1000820

(51) Int. Cl. F16K 1/226

(52) U.S. Cl. 251/306; 277/500

(57) ABSTRACT

The invention relates to an annular, endless sealing ring having a part (6) made of elastomeric material, perforated with two diametrically opposite through holes (9) and a part (7) made of ceramic exposed on the inner circumferential surface.

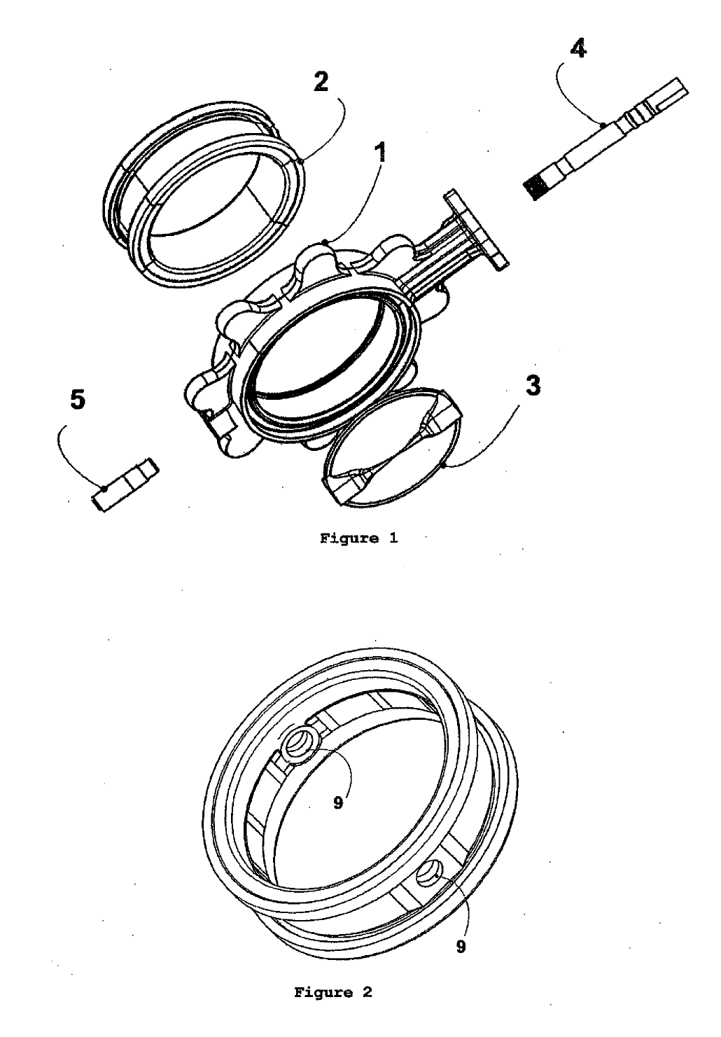

As illustrated in the exploded perspective view of FIG. 1, a butterfly valve comprises five main components. A body which surrounds a collar, also referred to as a sealing ring 2, which surrounds a closure member, also referred to as a butterfly or disc 3, operated by an operating shaft, also referred to as an upper shaft 4, opposite an axle which is also referred to as a lower axle 5.

The state of the art in the production of quarter-turn butterfly valves has led designers to often use elastomer materials as a sealing material for the collar, this material being incompatible with the closure disc.

The use of this principle provides an effective solution to the problem of sealing, but suffers from disadvantages, which are connected:
firstly, the friction coefficient between the elastomer material and the metal, which is relatively great, therefore means that significant forces have to be produced in order to operate the disc;
secondly, the poor friction coefficient leads to progressive destruction of the surfaces of the elastomer material, which impairs the sealing in the long term and therefore reduces the service-life of the valve;
thirdly, the metal/elastomer torque has a friction coefficient value which is very different between static and dynamic application, in particular for liquid fluids; the static friction torque being very much greater than the dynamic torque, consequently, during operations which require small movements, such as in control applications, the very great forces which are required to initiate the movement must be very rapidly reduced as soon as the movement is initiated, otherwise the valve will be found to have moved beyond the desired value.

The invention relates to a sealing ring which overcomes these disadvantages.

The endless annular sealing ring which has a portion of elastomer material, through which two diametrically opposed through-holes extend, is characterised by an exposed portion of ceramic material on the internal circumferential face.

The invention combines the qualities of two components, elastomer material, for its properties of resilience, and ceramic material, for its excellent friction coefficient with respect to metal materials and metal materials covered with ceramic material.

The elastomer portion which surrounds the body of the valve thus performs a plurality of functions:
it allows the body to be completely isolated from contact with the fluid to be conveyed,
it supports the ceramic components and provides the resilience required to produce contact forces which are sufficient to ensure sealing with respect to the fluid to be conveyed,
it ensures the sealing with respect to the passages of the shafts and that of the valve with respect to the faces of flanges of the pipes, which prevents external leaks.

The lowest friction of the sealing ring is obtained when the ceramic portion extends over the centre circle of the internal circumferential face, thus providing symmetry. The width of the ceramic portion preferably represents from ⅕th to ⅘th of the width of the internal circumferential face.

According to one embodiment, the ceramic portion comprises studs which are retained in apertures which are provided in the elastomer portion, the studs preferably being angularly distributed in a regular manner between the two through-holes, whilst the through-holes are surrounded by their own studs.

Preferably, the elastomer portion is flush or extends beyond the ceramic portion at the internal circumferential face so as to ensure sealing between the ceramic studs, this also ensuring sealing at the edges.

The circumferential length of a stud preferably represents from 1/12th to 1/36th of the circumferential distance between two consecutive studs. The circumferential distance between two studs preferably represents between 1/24th and 1/120th of the internal circumferential distance of the ring.

It is possible to produce the sealing ring according to the invention using different methods, one of which described below involves the presence of a coated resilient washer in the elastomer portion connecting the studs.

According to another embodiment, the studs have dovetail-like lugs which are blocked in the elastomer portion.

The ceramic studs which are blocked in the elastomer portion may further be vulcanised or adhesively bonded to the elastomer portion.

The invention also relates to the use of a ring according to the invention in a butterfly valve.

In the appended drawings, given purely by way of example:

FIG. 1 is an exploded perspective view of a valve according to the current prior art;

FIG. 2 is a perspective view of a sealing ring according to the invention;

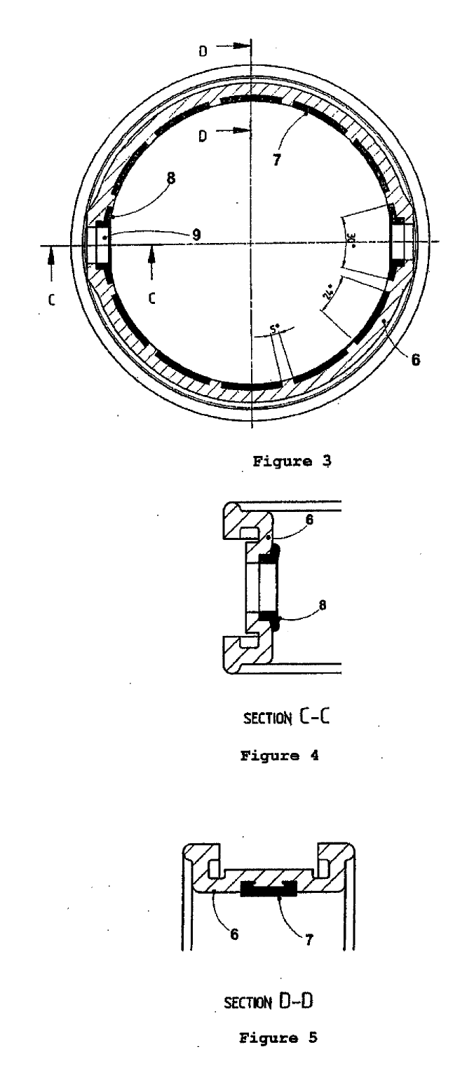

FIG. 3 is a sectioned view along a circumferential centre plane of the ring according to the invention;

FIG. 4 is a sectioned view along the line C-C of FIG. 3;

FIG. 5 is a sectioned view along the line D-D of FIG. 3;

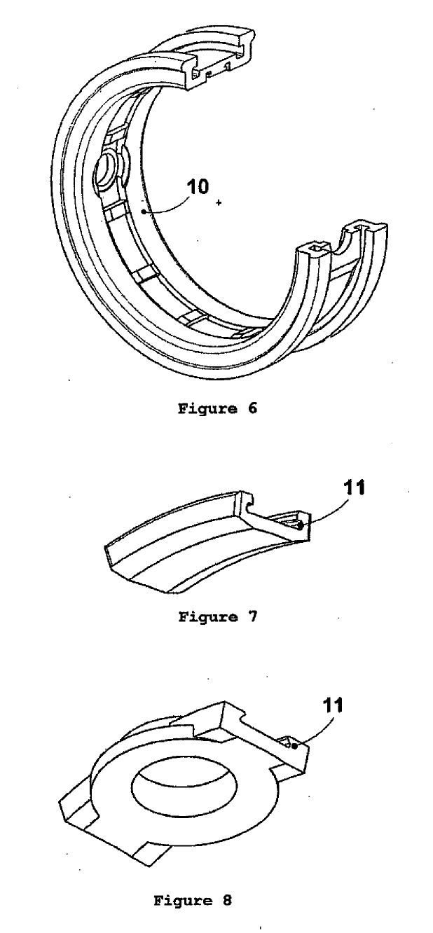

FIG. 6 is a partial perspective view of an embodiment of a sealing ring according to the invention, whilst

FIGS. 7 and 8 are perspective views of studs used in the ring of FIG. 6.

The ring is composed of three types of component:
a component 6 of elastomer material,
ceramic studs 7 having a linear cross-section,
ceramic studs 8 for passage of an axle.

The studs 8 surround diametrically opposed axle passages. The studs 7 have a length which corresponds to an angular sector of between 10 and 30 degrees. Each stud is at a distance from the adjacent stud corresponding to an angular sector of between 3 and 15 degrees.

It is possible to produce the sealing ring according to the invention using two production methods:
Method No. 1: overmoulding by means of injection or compression
Before the injection, all the ceramic components are placed inside the mould and mechanically fixed in place by means of a resilient spring type washer which will remain moulded with the ring.
The preferred production method is moulding by means of compression or injection of the elastomer material which allows the ring to be moulded in a mould to the definitive shapes of the component to be obtained. This moulding will surround the studs which form a composite component which is formed from the two materials, of which one is resilient, in order to ensure the clamping, and the other is hard and has a good surface state, in order to ensure the sealing.
Method No. 2:
The second method provides for the moulding of the elastomer ring to the specific shapes of the component with apertures 10 provided in order to accommodate the ceramic studs 7, 8. In this manner, the studs 7, 8 are mounted in the ring after moulding thereof and are blocked in the elastomer material by the dovetail shape of the lug 11 of the studs.
In addition to the mechanical blocking by the dovetail shape, the ceramic studs may be adhesively bonded to the elastomer by means of a vulcanisation solution which renders the assembly of components fixedly joined with the temperature being maintained for some tens of minutes.

1. Endless annular sealing ring which has a portion (6) of elastomer material, through which two diametrically opposed through-holes (9) extend, characterised by an exposed portion (7) of ceramic material on the internal circumferential face.

2. Ring according to claim 1, characterised in that the ceramic portion (7) extends over the centre circle of the internal circumferential face.

3. Ring according to claim 1, characterised in that the ceramic portion comprises studs (7, 8) which are retained in apertures provided in the elastomer portion.

4. Ring according to claim 3, characterised in that the studs (7) are distributed angularly in a regular manner between the through-holes (9).

5. Ring according to claim 3, characterised in that the through-holes (9) are surrounded by a ceramic stud (8).

6. Ring according to claim 1, characterised in that the elastomer portion (6) is flush or extends beyond the ceramic portion (7, 8) at the internal circumferential face.

7. Ring according to claim 3, characterised in that the circumferential length of a stud represents from 1/12th to 1/36th of the internal circumferential distance of the ring.

8. Ring according to claim 3, characterised in that the circumferential distance between two studs represents between 1/24th and 1/120th of the internal circumferential distance of the ring.

9. Ring according to claim 3, characterised by a coated resilient washer (10) in the elastomer portion (6) connecting the studs (7, 8).

10. Ring according to claim 3, characterised by studs whose dovetail-like lugs (11) are blocked in the elastomer portion (6).

11. Use of a ring according to claim 1 in a butterfly valve.
